(19) United States
(12) Patent Application Publication
(10) Pub. No.: US 2026/0135244 A1
(43) Pub. Date: May 14, 2026

(54) POWER STORAGE DEVICE

(71) Applicant: TOYOTA JIDOSHA KABUSHIKI KAISHA, Toyota-shi (JP)

(72) Inventors: Makoto Iwata, Toyota-shi (JP); Shotaro Ishikawa, Miyoshi-shi (JP); Shunsuke Fujiwara, Toyota-shi (JP); Soichiro Nakamura, Toyota-shi (JP); Takahiko Nakano, Toyota-shi (JP); Kosuke Suzuki, Toyota-shi (JP); Masahiro Ishizuka, Toyota-shi (JP); Kensuke Matsuo, Seto-shi (JP); Kazuya Kumazawa, Nagoya-shi (JP)

(73) Assignee: TOYOTA JIDOSHA KABUSHIKI KAISHA, Toyota-shi (JP)

(21) Appl. No.: 19/296,052

(22) Filed: Aug. 11, 2025

(30) Foreign Application Priority Data
Nov. 13, 2024 (JP) 2024-198014

(51) Int. Cl. H01M 50/358; B60L 50/64; H01M 10/613; H01M 10/625; H01M 10/647; H01M 10/653; H01M 10/6555; H01M 10/6568; H01M 50/342

(52) U.S. Cl. CPC H01M 50/358; H01M 10/613; H01M 10/625; H01M 10/647; H01M 10/653; H01M 10/6555; H01M 10/6568; H01M 50/3425; B60L 50/64; H01M 2220/20

(57) ABSTRACT

A power storage device includes: at least one power storage cell, a cooling plate; a lower case including a bottom wall; a panel member defining a smoke exhaust path together with the bottom wall; and refrigerant piping through which a refrigerant to be supplied to the cooling plate flows. A safety valve is provided in a lower surface of each power storage cell. The lower case includes a contact portion that contacts the smoke exhaust path. The refrigerant piping is in thermal contact with the contact portion.

### CROSS-REFERENCE TO RELATED APPLICATION

This application claims priority to Japanese Patent Application No. 2024-198014 filed on Nov. 13, 2024. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

Japanese Unexamined Patent Application Publication No. 2023-126584 (JP 2023-126584 A), for example, discloses a battery including a plurality of cells, a case that houses the cells, a protective member that protects a bottom portion of the case, and a cover. Each of the cells includes a box that houses an electrode assembly. A relief mechanism is provided in a bottom surface of the box. Exhaust discharged from the relief mechanism flows into a collection cavity formed between the bottom portion of the case and the protective member.

### SUMMARY

In the battery described in JP 2023-126584 A, a gas that has flowed into the collection cavity may be discharged into the atmosphere through an explosion-proof valve or the like. In this case, there is a concern that a gas at a high temperature may be discharged into the atmosphere.

An object of the present disclosure is to provide a power storage device capable of lowering the temperature of a gas discharged into the atmosphere.

An aspect of the present disclosure provides a power storage device including: at least one power storage cell; a cooling plate that cools the at least one power storage cell; a lower case including a bottom wall disposed below the at least one power storage cell and the cooling plate; a panel member provided below the bottom wall and defining a smoke exhaust path together with the bottom wall; and refrigerant piping through which a refrigerant to be supplied to the cooling plate flows, in which: a safety valve is provided in a lower surface of the at least one power storage cell; the lower case includes a contact portion that contacts the smoke exhaust path; and the refrigerant piping is in thermal contact with the contact portion.

According to the present disclosure, it is possible to provide a power storage device capable of lowering the temperature of a gas discharged into the atmosphere.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating a power storage device according to an embodiment of the present disclosure;

FIG. 2 is a plan view schematically illustrating a state in which an upper cover has been removed from the power storage device;

FIG. 3 is a cross-sectional view taken along the line III-III in FIG. 2;

FIG. 4 is a cross-sectional view taken along the line IV-IV in FIG. 2;

FIG. 5 is a cross-sectional view schematically illustrating a modification of a lower case; and

FIG. 6 is a cross-sectional view schematically illustrating a modification of the lower case.

### DETAILED DESCRIPTION OF EMBODIMENTS

An embodiment of the present disclosure will be described with reference to the drawings. In the drawings referred to below, the same or corresponding members are given the same numerals.

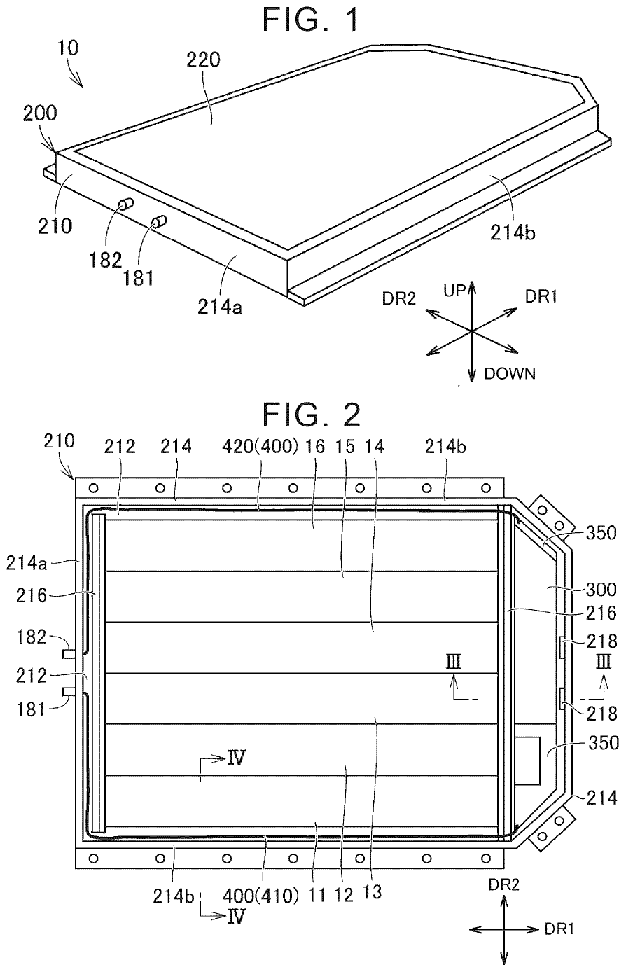

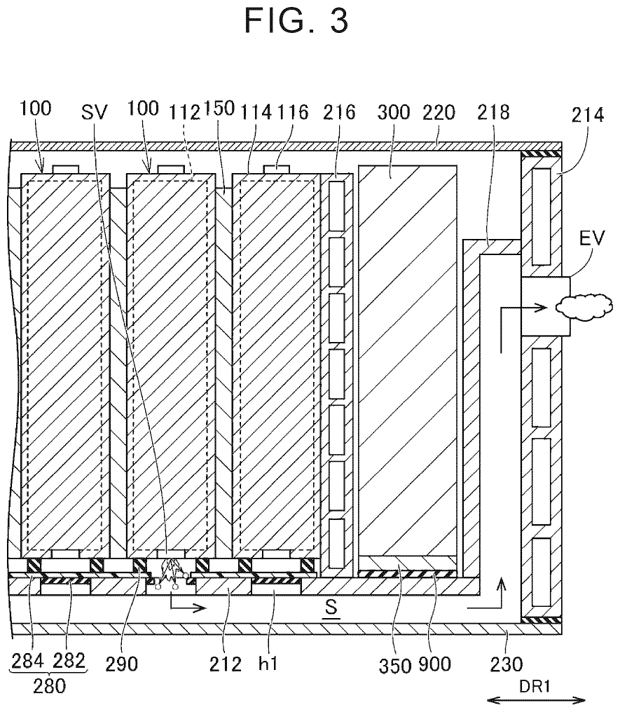

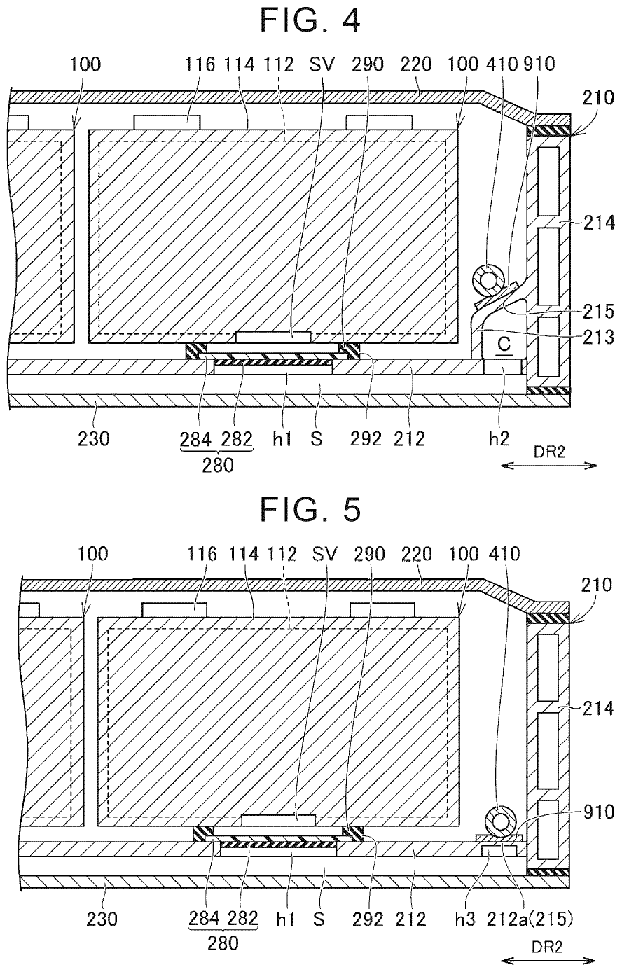

FIG. 1 is a perspective view schematically illustrating a power storage device according to an embodiment of the present disclosure. FIG. 2 is a plan view schematically illustrating a state in which an upper cover has been removed from the power storage device. FIG. 3 is a cross-sectional view taken along the line III-III in FIG. 2. FIG. 4 is a cross-sectional view taken along the line IV-IV in FIG. 2.

A power storage device 10 according to the present embodiment is mounted in, for example, a lower part of a vehicle. The vehicle is, for example, a hybrid electric vehicle, a plug-in hybrid electric vehicle, or a battery electric vehicle.

As illustrated in FIGS. 1 to 4, the power storage device 10 includes six power storage stacks 11 to 16, a housing 200, a protective member 280, devices 300, a device cooler 350, and refrigerant piping 400. The number of the power storage stacks is not limited to six.

Each of the power storage stacks 11 to 16 is formed in the shape of a rectangular parallelepiped that is elongated in a first direction DR1. As illustrated in FIG. 2, the six power storage stacks 11 to 16 are disposed side by side along a second direction DR2 that is orthogonal to both the first direction DR1 and the up-down direction. In the present embodiment, the first direction DR1 corresponds to the front-rear direction of the vehicle, and the second direction DR2 corresponds to the right-left direction (width direction) of the vehicle. Each of the power storage stacks 11 to 16 includes at least one power storage cell 100. In the present embodiment, each of the power storage stacks 11 to 16 includes a plurality of power storage cells 100 and a plurality of cooling plates 150.

The power storage cells 100 are disposed side by side along the first direction DR1. As illustrated in FIG. 3, each of the power storage cells 100 includes an electrode body 112, a cell case 114, and a pair of external terminals 116.

The electrode body 112 may be composed of a wound body in which a positive electrode sheet and a negative electrode sheet are wound via a separator, or may be composed of a stacked body in which a positive electrode sheet and a negative electrode sheet are stacked via a separator. The electrode body 112 is shaped to be elongated in the second direction DR2.

The cell case 114 houses the electrode body 112. The cell case 114 is formed in a rectangular parallelepiped shape. The cell case 114 is made of a metal such as aluminum. A safety valve SV is provided in a lower surface of the cell case 114.

The external terminals 116 are provided on an upper surface of the cell case 114. The external terminals 116 are provided at positions spaced apart from each other in the width direction of the cell case 114. The width direction of the cell case 114 corresponds to the second direction DR2.

As illustrated in FIG. 3, each of the cooling plates 150 is disposed between a pair of power storage cells 100 adjacent to each other in the first direction DR1. Each of the cooling plates 150 is formed in the shape of a flat plate that is elongated in the second direction DR2. Each of the cooling plates 150 has a flow path (not illustrated) through which a refrigerant flows along the second direction DR2.

The housing 200 houses the six power storage stacks 11 to 16. As illustrated in FIGS. 1 to 4, the housing 200 includes a lower case 210, an upper cover 220, and a panel member 230.

The lower case 210 is open upward. The lower case 210 may be made of a metal such as aluminum. The lower case 210 includes a bottom wall 212, a peripheral wall 214, and a pair of partition walls 216.

The bottom wall 212 is located below the power storage stacks 11 to 16. The bottom wall 212 may be formed as a solid flat plate. The bottom wall 212 may be formed to be hollow by extrusion. As illustrated in FIG. 3, a plurality of through holes h1 is formed in the bottom wall 212. Each of the through holes h1 is provided at a position facing the safety valve SV. The length of the through hole h1 in the first direction DR1 is greater than the length of the safety valve SV in the first direction DR1. The length of the through hole h1 in the second direction DR2 is greater than the length of the safety valve SV in the second direction DR2.

The protective member 280 is provided on the bottom wall 212. As illustrated in FIGS. 3 and 4, the protective member 280 includes a plurality of heat insulating members 282 and a holding sheet 284.

Each of the heat insulating members 282 is provided within the through hole h1. Each of the heat insulating members 282 is shaped to close the through hole h1. In the present embodiment, the upper surface of the heat insulating members 282 is set to be flush with the upper surface of the bottom wall 212. The heat insulating members 282 have a function of protecting the power storage cells 100 from the gas discharged from the safety valve SV. The heat insulating members 282 are made of, for example, mica obtained by solidifying a natural inorganic mineral by heat pressing.

The holding sheet 284 holds the heat insulating members 282. The heat insulating members 282 may be adhered to the back surface of the holding sheet 284. The holding sheet 284 is made of, for example, polypropylene.

The peripheral wall 214 is connected to the bottom wall 212. The peripheral wall 214 is shaped to surround the power storage stacks 11 to 16. The peripheral wall 214 may be formed to be hollow. The peripheral wall 214 includes a front wall 214a and a pair of side walls 214b.

The front wall 214a is formed on one side (the left side in FIG. 2) of the power storage stacks 11 to 16 in the first direction DR1. The front wall 214a extends in the second direction DR2. In the present embodiment, the one side in the first direction DR1 corresponds to the front side in the front-rear direction of the vehicle.

The side walls 214b face each other at a distance from each other in the second direction DR2. The side walls 214b extend in the first direction DR1. An end portion (front end portion) of each of the side walls 214b on the one side in the first direction DR1 is connected to the front wall 214a.

The partition walls 216 partition a space surrounded by the bottom wall 212 and the peripheral wall 214 into a space in which the power storage stacks 11 to 16 are disposed and the other space. The partition walls 216 are disposed as spaced apart from each other in the first direction DR1. The partition walls 216 extend in the second direction DR2. The partition walls 216 may be formed to be hollow. The partition walls 216 have a function of restraining the power storage stacks 11 to 16 from both sides in the first direction DR1. As illustrated in FIG. 2, end portions, in the second direction DR2, of the partition wall 216 formed on the one side (front side) in the first direction DR1 are spaced apart from the respective side walls 214b. End portions, in the second direction DR2, of the partition wall 216 formed on the other side (rear side) in the first direction DR1 are connected to the respective side walls 214b.

The upper cover 220 is disposed above the power storage stacks 11 to 16. The upper cover 220, together with the lower case 210, houses the six power storage stacks 11 to 16. Specifically, the upper cover 220, together with the lower case 210, houses the six power storage stacks 11 to 16 in a sealed state. The peripheral edge portion of the upper cover 220 is connected to the upper end portion of the peripheral wall 214 by bolts or the like via a seal member.

The panel member 230 is provided below the lower case 210. The panel member 230 has a function of protecting the bottom wall 212 of the lower case 210. The panel member 230 may be formed in a flat plate shape. The peripheral edge portion of the panel member 230 is connected to the lower surface of the lower case 210 via a seal member.

As illustrated in FIG. 3, a space S is formed between the panel member 230 and the bottom wall 212. The space S functions as a smoke exhaust path (hereinafter referred to as a “smoke exhaust path S”). The smoke exhaust path S is a path for discharging a gas discharged from the safety valve SV of the power storage cell 100 to the outside of the housing 200.

As illustrated in FIGS. 2 and 3, a smoke exhaust duct portion 218 is formed on the peripheral wall 214. The smoke exhaust duct portion 218 extends upward from the bottom wall 212. The smoke exhaust duct portion 218 guides a gas upward from the smoke exhaust path S. An explosion-proof valve EV is provided at the downstream end portion of the smoke exhaust duct portion 218. The explosion-proof valve EV releases the pressure within the housing 200. The explosion-proof valve EV opens when the pressure within the housing 200 becomes equal to or greater than a reference value. The explosion-proof valve EV is composed of a check valve. As illustrated in FIG. 3, when a gas is discharged from any of the power storage cells 100, the gas spreads in the first direction DR1 through the smoke exhaust path S and is discharged to the outside of the housing 200 through the smoke exhaust duct portion 218 and the explosion-proof valve EV.

As illustrated in FIG. 4, in the present embodiment, the lower case 210 includes a corner wall 213 that contacts both the upper surface of the bottom wall 212 and the inside surface of the peripheral wall 214. The corner wall 213 has an internal space C. The corner wall 213 includes a contact portion 215 that contacts the smoke exhaust path S. The bottom wall 212 is provided with a communication port h2 formed to communicate the smoke exhaust path S and the internal space C. In the present embodiment, the contact portion 215 is constituted by the upper part of the corner wall 213.

A surrounding member 290 is provided between the lower surface of the power storage cells 100 and the upper surface of the bottom wall 212. The surrounding member 290 is shaped to surround the through holes h1. In the present embodiment, the surrounding member 290 is provided between the bottom surface of the cell case 114 and the holding sheet 284. The lower surface of the surrounding member 290 is in contact with the holding sheet 284 located on the upper surface of the bottom wall 212. The upper surface of the surrounding member 290 may be in contact with the bottom surface of the cell case 114. The surrounding member 290 is made of a resin, a metal, or the like. The surrounding member 290 may be in contact with the lower surface of the cooling plates 150.

The devices 300 are housed in the housing 200. As illustrated in FIG. 2, the devices 300 are disposed on the other side of the lower case 210 in the first direction DR1, that is, in a space formed between the partition wall 216 formed on the other side (rear side) in the first direction DR1 and the peripheral wall 214. The devices 300 may include a junction box. The devices 300 may include a relay, a control device, and the like.

The device cooler 350 cools the devices 300. As illustrated in FIGS. 2 and 3, the device cooler 350 is provided between the bottom wall 212 and the devices 300. A thermally conductive adhesive 900 may be provided between the device cooler 350 and the bottom wall 212.

The refrigerant piping 400 is routed inside the housing 200. The refrigerant piping 400 is connected to the cooling plates 150 and the device cooler 350. As illustrated in FIGS. 1 and 2, the front wall 214a of the peripheral wall 214 is provided with an inlet port 181 and an outlet port 182. The refrigerant piping 400 is connected to the inlet port 181 and the outlet port 182. Therefore, the refrigerant (such as water or oil) supplied from the inlet port 181 flows into the cooling plates 150 and the device cooler 350 through the refrigerant piping 400, cools the power storage cells 100 and the devices 300, and then flows out from the outlet port 182 through the refrigerant piping 400.

As illustrated in FIG. 2, the refrigerant piping 400 includes upstream piping 410 and downstream piping 420.

The upstream end portion of the upstream piping 410 is connected to the inlet port 181. The downstream end portion of the upstream piping 410 is connected to one end portion of the device cooler 350 in the second direction DR2. The upstream piping 410 is routed to pass between the front wall 214a and the partition wall 216 formed on the one side in the first direction DR1, and between the power storage stack 11 disposed on one side in the second direction DR2 and the side wall 214b. The upstream piping 410 is connected to one end portion of each of the cooling plates 150 in the second direction DR2.

The upstream end portion of the downstream piping 420 is connected to the other end portion of the device cooler 350 in the second direction DR2. The downstream end portion of the downstream piping 420 is connected to the outlet port 182. The downstream piping 420 is routed to pass between the front wall 214a and the partition wall 216 formed on the one side in the first direction DR1, and between the power storage stack 16 disposed on the other side in the second direction DR2 and the side wall 214b. The downstream piping 420 is connected to the other end portion of each of the cooling plates 150 in the second direction DR2.

The refrigerant piping 400 is in thermal contact with the contact portion 215. The thermal contact includes a state in which the refrigerant piping 400 is in direct contact with the contact portion 215 and a state in which the refrigerant piping 400 is in indirect contact with the contact portion 215 via a thermally conductive member (such as an adhesive or a buffer member). As illustrated in FIG. 4, the power storage device 10 according to the present embodiment further includes a buffer member 910 provided between the upstream piping 410 and the contact portion 215. The buffer member 910 is made of a thermally conductive material. Although not illustrated, a buffer member 910 is also provided between the downstream piping 420 and the contact portion 215.

In the power storage device 10 described above, when exhaust is discharged downward from the safety valve SV because of a short circuit or the like in any of the power storage cells 100, the exhaust collides against the holding sheet 284 and the heat insulating member 282. Then, the holding sheet 284 melts and the heat insulating member 282 breaks open, and therefore the exhaust containing the content (so-called debris) of the power storage cell 100 flows into the smoke exhaust path S through the through hole h1. Thereafter, the gas contained in the exhaust spreads in the smoke exhaust path S and is discharged from the housing 200 through the explosion-proof valve EV as illustrated in FIG. 3. Thus, the adhesion of the content of the power storage cell 100 to the external terminals 116 and the like is suppressed.

In the present embodiment, when the gas spreads in the smoke exhaust path S, a portion of the gas in the smoke exhaust path S is cooled by the refrigerant flowing through the refrigerant piping 400 via the contact portion 215, and therefore the temperature of the gas discharged from the smoke exhaust path S into the atmosphere through the explosion-proof valve EV is lowered.

Modifications of the above embodiment will be described below.

### First Modification

As illustrated in FIG. 5, the corner wall 213 may be omitted from the lower case 210, and an edge portion 212a of the bottom wall 212 may constitute the contact portion 215. In this case, as illustrated in FIG. 5, a recess h3 recessed upward may be provided in the lower surface of the edge portion 212a of the bottom wall 212.

### Second Modification

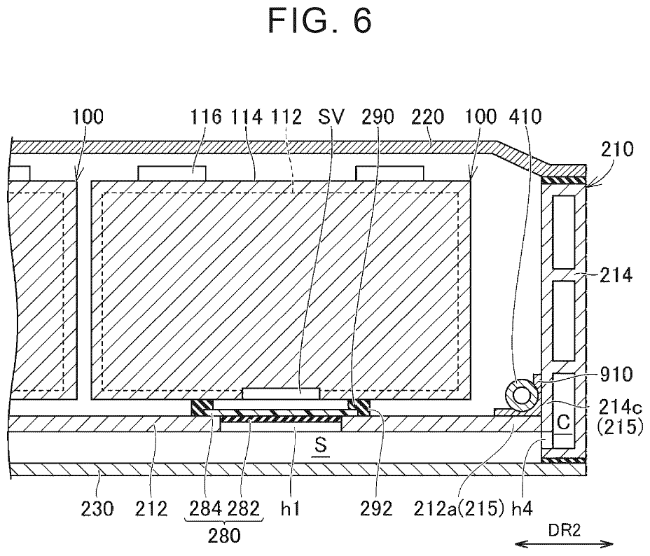

As illustrated in FIG. 6, the corner wall 213 may be omitted from the lower case 210, and an edge portion 212a of the bottom wall 212 and a lower part 214c of the inside surface of the peripheral wall 214 may constitute the contact portion 215. In this example, the peripheral wall 214 has an internal space C, and the inside wall of the peripheral wall 214 is provided with a communication port h4 formed to communicate the smoke exhaust path S and the internal space C.

It will be understood by a person skilled in the art that the exemplary embodiment described above is a specific example of the following aspects.

### First Aspect

A Power Storage Device Including:
at least one power storage cell;
a cooling plate that cools the at least one power storage cell;
a lower case including a bottom wall disposed below the at least one power storage cell and the cooling plate;
a panel member provided below the bottom wall and defining a smoke exhaust path together with the bottom wall; and
refrigerant piping through which a refrigerant to be supplied to the cooling plate flows, in which:
a safety valve is provided in a lower surface of the at least one power storage cell;
the lower case includes a contact portion that contacts the smoke exhaust path; and
the refrigerant piping is in thermal contact with the contact portion.

In this aspect, the gas in the smoke exhaust path is cooled by the refrigerant flowing through the refrigerant piping via the contact portion, and therefore the temperature of the gas discharged from the smoke exhaust path into the atmosphere is lowered.

### Second Aspect

The power storage device according to the first aspect, in which:
the lower case further includes
   a peripheral wall connected to the bottom wall and surrounding the at least one power storage cell and the cooling plate, and
   a corner wall that contacts both an upper surface of the bottom wall and an inside surface of the peripheral wall and has an internal space;
the corner wall includes the contact portion; and
the bottom wall is provided with a communication port that communicates the smoke exhaust path and the internal space.

In this aspect, the peripheral wall is reinforced by the corner wall, and the gas that has flowed into the internal space through the communication port is effectively cooled in the internal space.

### Third Aspect

The power storage device according to the second aspect, further including a buffer member provided between the refrigerant piping and the contact portion, in which the buffer member is made of a thermally conductive material.

In this aspect, it is possible to both protect the refrigerant piping and ensure good thermal contact between the refrigerant piping and the contact portion.

### Fourth Aspect

The power storage device according to the first aspect, in which:
the lower case further includes a peripheral wall connected to the bottom wall and surrounding the at least one power storage cell and the cooling plate;
the peripheral wall has an internal space; and
the peripheral wall is provided with a communication port that communicates the smoke exhaust path and the internal space.

The embodiment disclosed herein should be considered to be exemplary in all respects and not restrictive. The scope of the present disclosure is defined by the claims rather than the above description of the embodiment, and further includes all modifications that fall within the meaning and scope equivalent to the claims.

What is claimed is:

1. A power storage device comprising:
at least one power storage cell;
a cooling plate that cools the at least one power storage cell;
a lower case including a bottom wall disposed below the at least one power storage cell and the cooling plate;
a panel member provided below the bottom wall and defining a smoke exhaust path together with the bottom wall; and
refrigerant piping through which a refrigerant to be supplied to the cooling plate flows, wherein:
a safety valve is provided in a lower surface of the at least one power storage cell;
the lower case includes a contact portion that contacts the smoke exhaust path; and
the refrigerant piping is in thermal contact with the contact portion.

2. The power storage device according to claim 1, wherein:
the lower case further includes
a peripheral wall connected to the bottom wall and surrounding the at least one power storage cell and the cooling plate, and
a corner wall that contacts both an upper surface of the bottom wall and an inside surface of the peripheral wall and has an internal space;
the corner wall includes the contact portion; and
the bottom wall is provided with a communication port that communicates the smoke exhaust path and the internal space.

3. The power storage device according to claim 2, further comprising a buffer member provided between the refrigerant piping and the contact portion, wherein the buffer member is made of a thermally conductive material.

4. The power storage device according to claim 1, wherein:
the lower case further includes a peripheral wall connected to the bottom wall and surrounding the at least one power storage cell and the cooling plate;
the peripheral wall has an internal space; and
the peripheral wall is provided with a communication port that communicates the smoke exhaust path and the internal space.
